(19) United States
(12) Patent Application Publication
(10) Pub. No.: US 2015/0362164 A1
(43) Pub. Date: Dec. 17, 2015

(54) Lighting Power Supply System

(71) Applicant: Inspired LED, LLC, Tempe, AZ (US)

(72) Inventors: James J. Levante, Tempe, AZ (US); Tanner J. Leland, Tempe, AZ (US)

(73) Assignee: Inspired LED, LLC

(21) Appl. No.: 14/301,715

(22) Filed: Jun. 11, 2014

(51) Int. Cl. F21V 23/00; F21V 23/02; F21V 23/04; H05B 33/08

(52) U.S. Cl. CPC F21V 23/001; H05B 33/0845; F21V 23/023; F21V 23/04

(57) ABSTRACT

A lighting power supply system for providing efficient installation and operation of a low voltage power supply within an existing electrical box. The lighting power supply system generally includes a housing formed and adapted to fit within a conventional electrical box, a low voltage power supply positioned within the housing and a power switch attached to the housing. The power switch is electrically connected to the low voltage power supply within the housing. A dimmer switch is attached to the housing and is electrically connected to the power switch to provide dimmable low voltage power to a light strip.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a low voltage power supply for lighting and more specifically it relates to a lighting power supply system for providing efficient installation and operation of a low voltage power supply within an existing electrical box.

2. Description of the Related Art

Any discussion of the related art throughout the specification should in no way be considered as an admission that such related art is widely known or forms part of common general knowledge in the field.

Low voltage power supplies are used to convert high voltage alternating current (AC) electrical power to low voltage direct current (DC) electrical power such as but not limited to 12 volts DC. Low voltage power supplies are used to provide electrical power to various items such as outdoor lighting, indoor lighting, light strips and flexible LED light strips. Light strips, such as flexible LED light strips, have become increasingly popular in various applications such as but not limited to under cabinet lighting, TV back lighting, staircase lighting, architectural lighting, bar lighting, kitchen lighting, toe kick lighting, ceiling cove lighting, decorations and vehicles. A flexible LED light strip is comprised of an elongated flexible strip of printed circuit board (PCB) having two or more electrically conductive traces to provide electrical power, a plurality of light-emitting diodes (LED) attached along the front surface of the flexible strip and electrically connected to the conductive traces, and a length of adhesive along the back surface of the flexible strip. The LEDs may emit the same light or may change colors to provide a range of light options. Most conventional flexible LED light strips utilize a low-voltage 12V DC electrical power.

Conventional light strips, including flexible LED light strips, require a low voltage power supply to be electrically connected by an installer to a separate light switch and a dimmer control. Hence, the installer much install both the light switch (with or without a dimmer control switch) and the low voltage power supply when installing a light strip within a building structure.

One type of low voltage power supply is comprised of a box design that hangs on a wall with the low voltage wires ran through the wall to the light switch. The main problem with conventional power supplies is that they are awkward to install since they must be attached to a wall and then have wires ran through the wall to the light switch. Another problem with conventional power supplies is that they are bulky and unsightly making them difficult to install in a professional looking manner.

Another type of low voltage power supply is comprised of a wall outlet plugin that plugs directly into the wall with the AC/DC converter outside of the wall outlet and the low voltage wires extending from the converter. The main problem with wall outlet power supplies is that they are unsightly and require the low voltage wires to be exposed. Another problem is the wall outlet power supplies require an AC power wall outlet near the light switch.

Because of the inherent problems with the related art, there is a need for a new and improved lighting power supply system for providing efficient installation and operation of a low voltage power supply within an existing electrical box.

### BRIEF SUMMARY OF THE INVENTION

The invention generally relates to a low voltage power supply for lighting which includes a housing formed and adapted to fit within a conventional electrical box, a low voltage power supply positioned within the housing and a power switch attached to the housing. The power switch is electrically connected to the low voltage power supply within the housing. A dimmer switch is attached to the housing and is electrically connected to the power switch to provide dimmable low voltage power to a light strip.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded upper perspective view of the present invention.

FIG. 2 is an upper perspective view of the present invention.

FIG. 3 is a front view of the present invention.

FIG. 4a is a side view of the present invention.

FIG. 4b is a side cutaway view of the present invention positioned within an electrical box.

FIG. 5 is a top view of the present invention.

FIG. 6 is a rear view of the present invention.

FIG. 7 is an exploded upper perspective view of the present invention with a toggle switch.

FIG. 8 is a block diagram of the present invention.

FIG. 9 is an exploded upper perspective view of the present invention without a power switch.

FIG. 10 is an upper perspective view of the present invention without a power switch.

FIG. 11 a front view of the present invention without a power switch.

FIG. 12a is a side view of the present invention without a power switch.

FIG. 12b is a side cutaway view of the present invention without a power switch position within an electrical box.

FIG. 13 is a side view of the present invention without a power switch.

FIG. 14 is a rear view of the present invention without a power switch.

### DETAILED DESCRIPTION OF THE INVENTION

### A. Overview

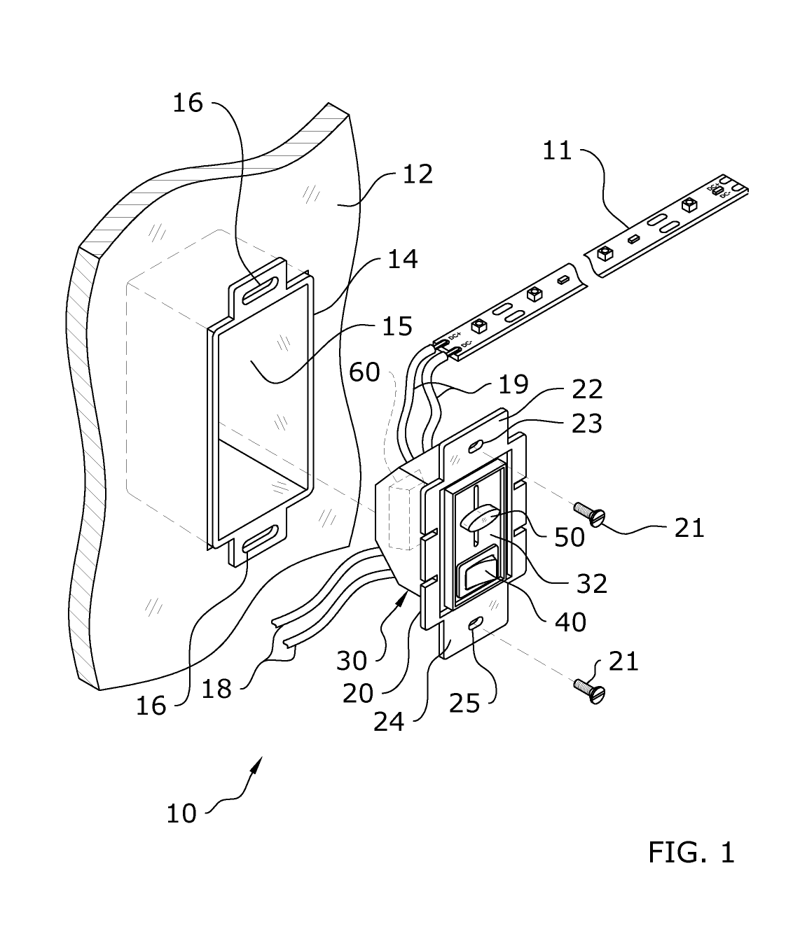

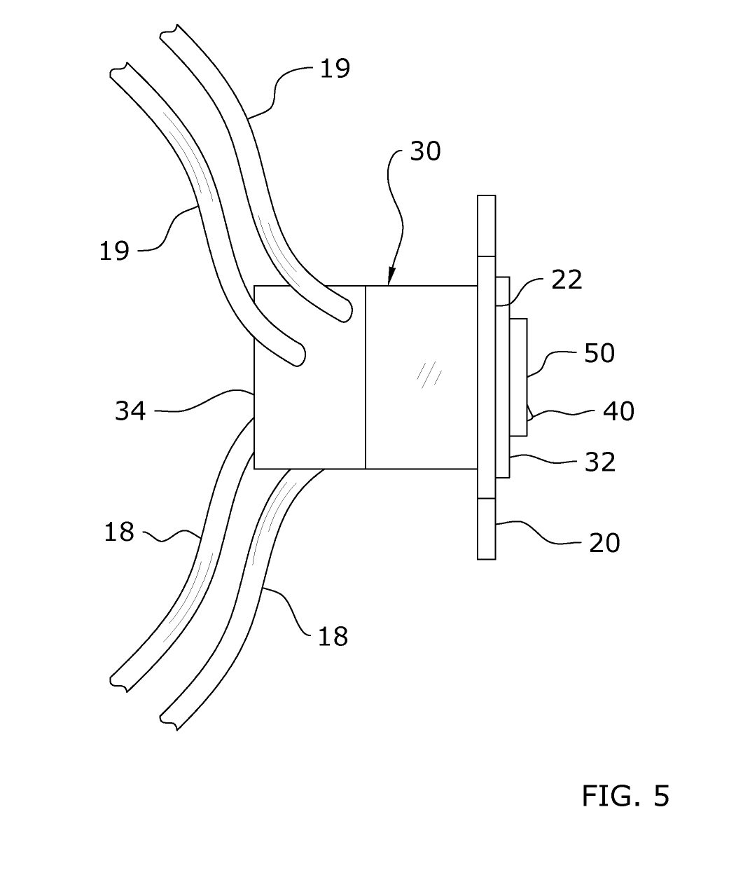

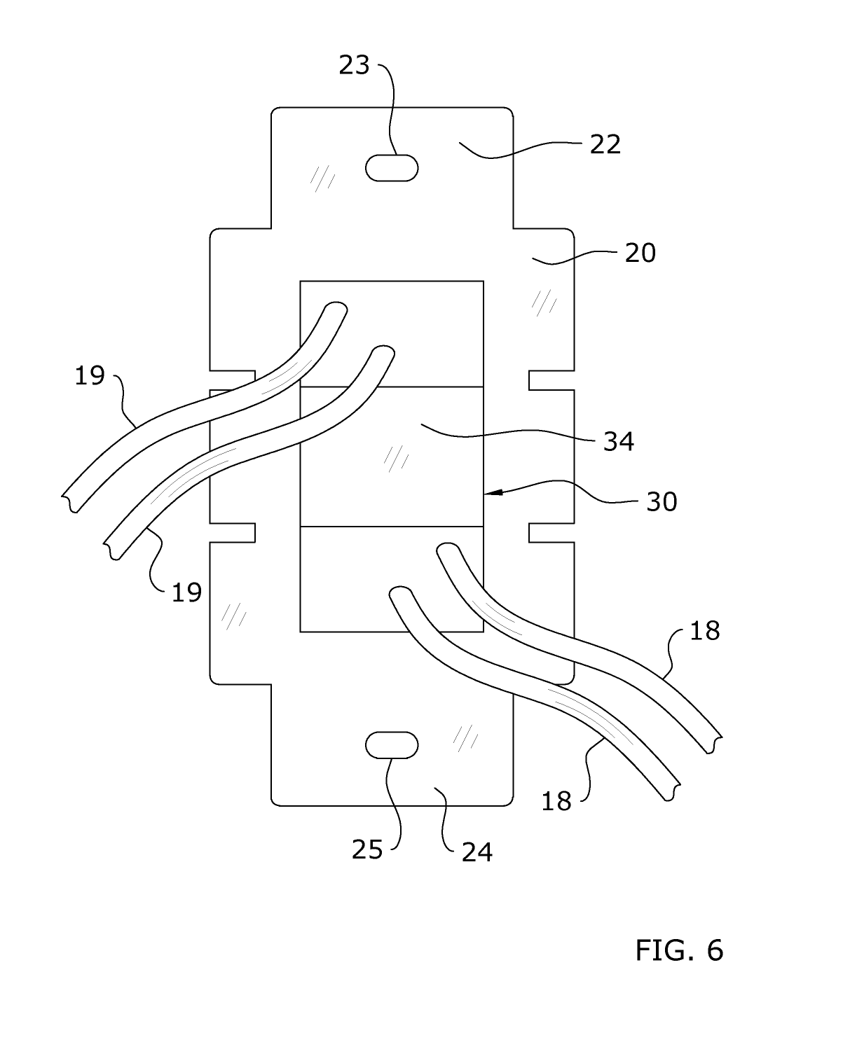

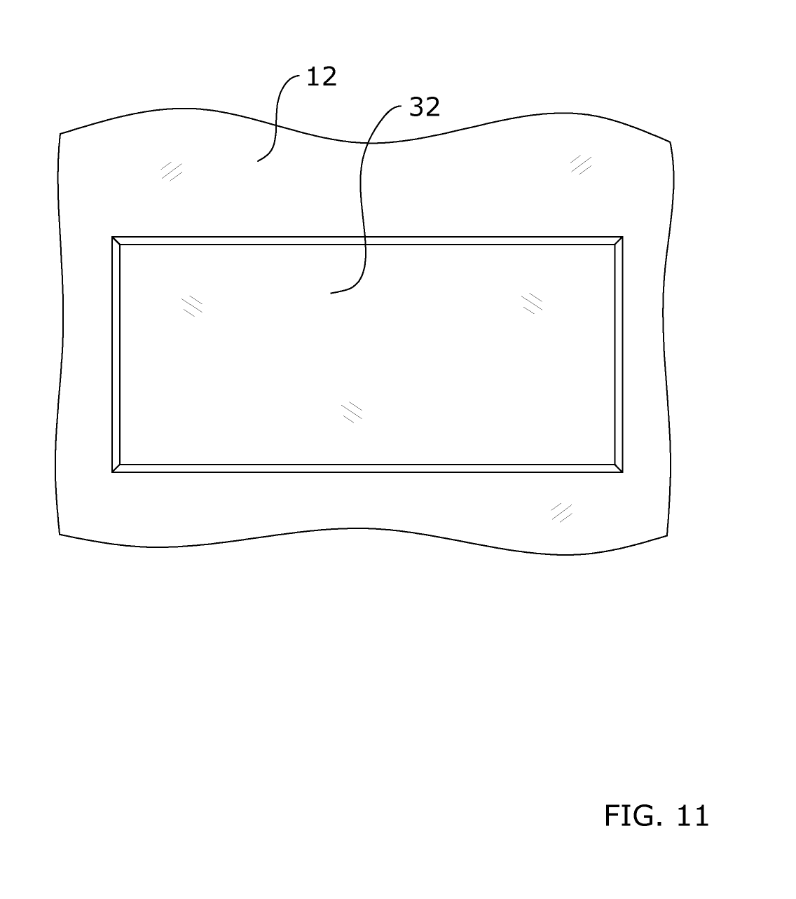

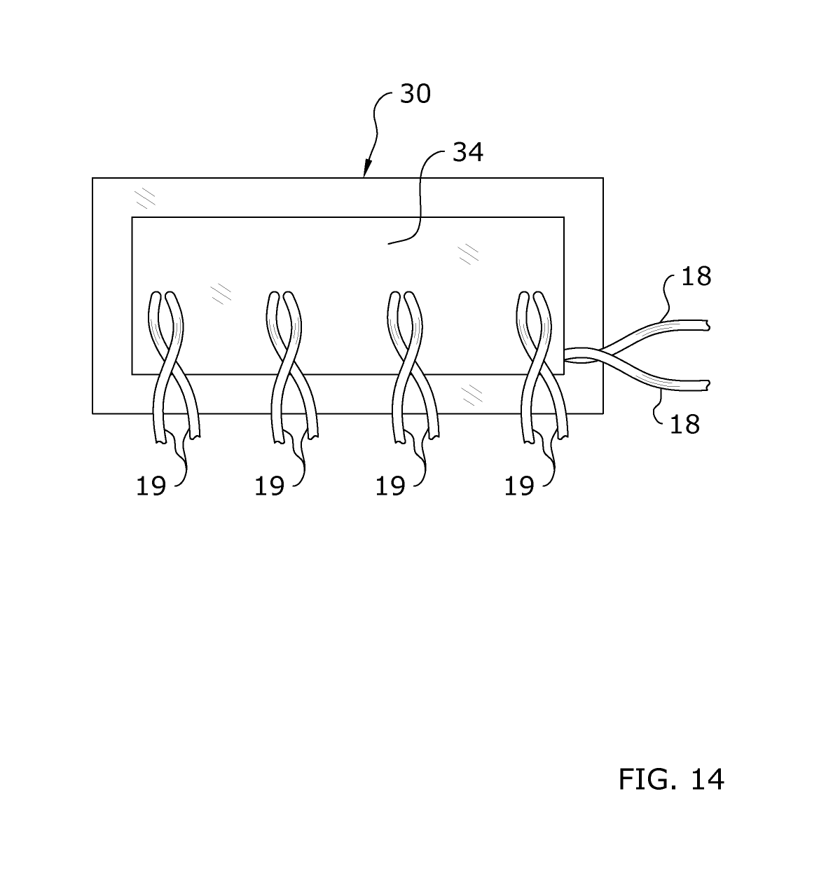

Turning now descriptively to the drawings, in which similar reference characters denote similar elements throughout the several views, FIGS. 1 through 14 illustrate a lighting power supply system 10, which comprises a housing 30 formed and adapted to fit within a conventional electrical box 14, a low voltage power supply 60 positioned within the housing 30 and a power switch 40 attached to the housing 30. The power switch 40 is electrically connected to the low voltage power supply 60 within the housing 30. A dimmer switch 50 is attached to the housing 30 and is electrically connected to the power switch 40 to provide dimmable low voltage power to a light strip.

### B. Electrical Box

FIGS. 1, 2, 3, 4, 7, 9, 10 and 12b illustrate an exemplary electrical box 14 suitable for usage in combination with the present invention. The electrical box 14 is comprised of a structure that is adapted to receive electrical devices and is mountable to a wall 12 (e.g. to a stud in a wall 12). The electrical box 14 may be comprised of various types of materials such as metal, plastic or PVC.

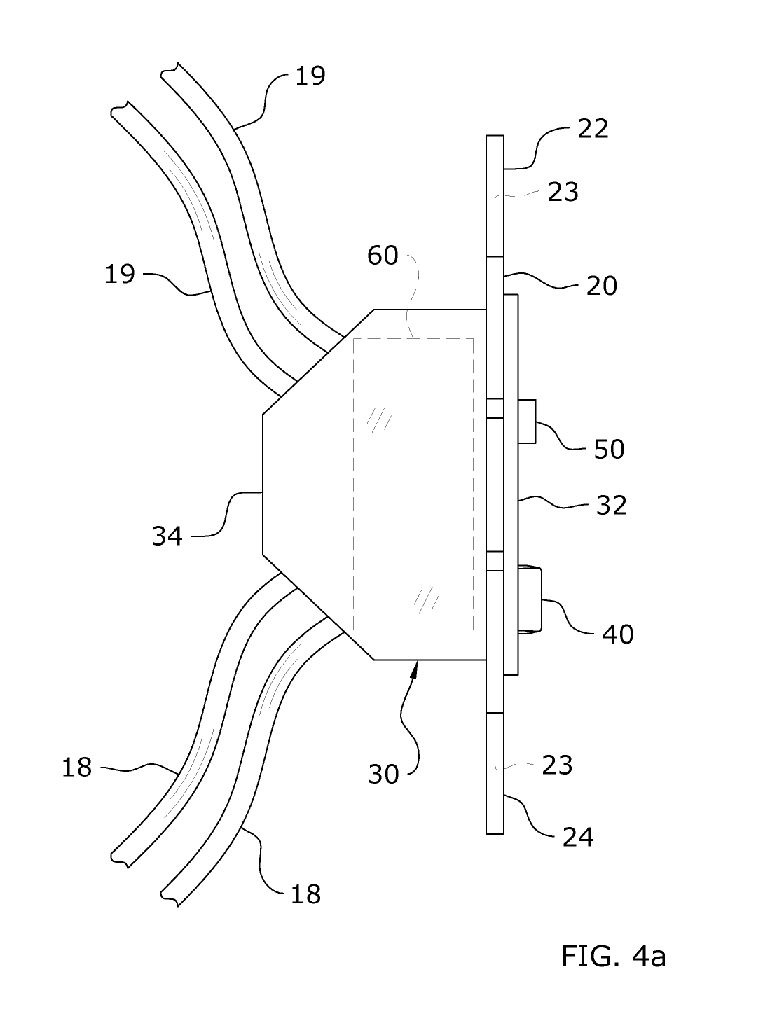

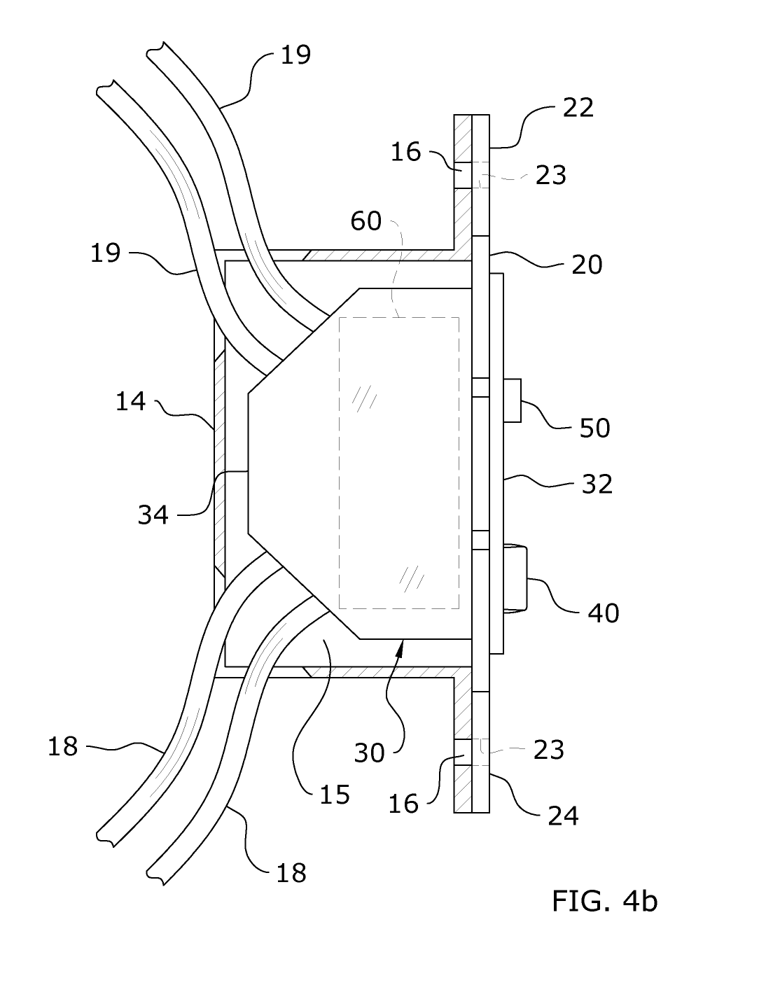

The electrical box 14 is comprised of a box structure having a front opening that receives the housing 30 as illustrated in FIG. 1 of the drawings. The housing 30 has a shape and size smaller than the front opening of the electrical box 14 to allow for the housing 30 to be inserted into the box interior 15 of the electrical box 14. The electrical box 14 preferably has one or more openings to allow for the wires 18, 19 to extend through. For example, the openings within the electrical box 14 may extend through various portions of the electrical box 14 as illustrated in FIG. 4b of the drawings.

The electrical box 14 is preferably comprised of a rectangular structure and in particular preferably comprised of a rectangular cuboid structure as illustrated in FIG. 1 of the drawings. The electrical box 14 preferably includes an upper tab having an upper tab aperture and a lower tab having a lower tab aperture that threadably receive corresponding threaded fasteners 21 that extend through openings in the housing 30 to secure the housing 30 to the electrical box 14.

The electrical box 14 is preferably comprised of a conventional switch box that is adapted to receive one or more electrical switches (e.g. a light switch, power outlet). For example, the electrical box 14 may be comprised of a new-work box, an old-work box, an outdoor box, a handy box and the like commonly utilized to house light switches. The electrical box 14 may be attached to the wall 12 such as the sheetrock and/or a stud within the wall 12 which is well known in the art of electrical box 14es.

FIGS. 1 through 3 illustrate an electrical box 14 comprised of a conventional single gang box that is adapted to receive a single electrical switch. One or more of the conventional single gang boxes may be positioned adjacent to one another as needed. The electrical box 14 illustrated in FIGS. 1 through 3 preferably has a size of approximately 3 inches tall×2 inches wide×2.5 inches deep. Various other sizes may be utilized for the electrical box 14 illustrated in FIGS. 1 through 3.

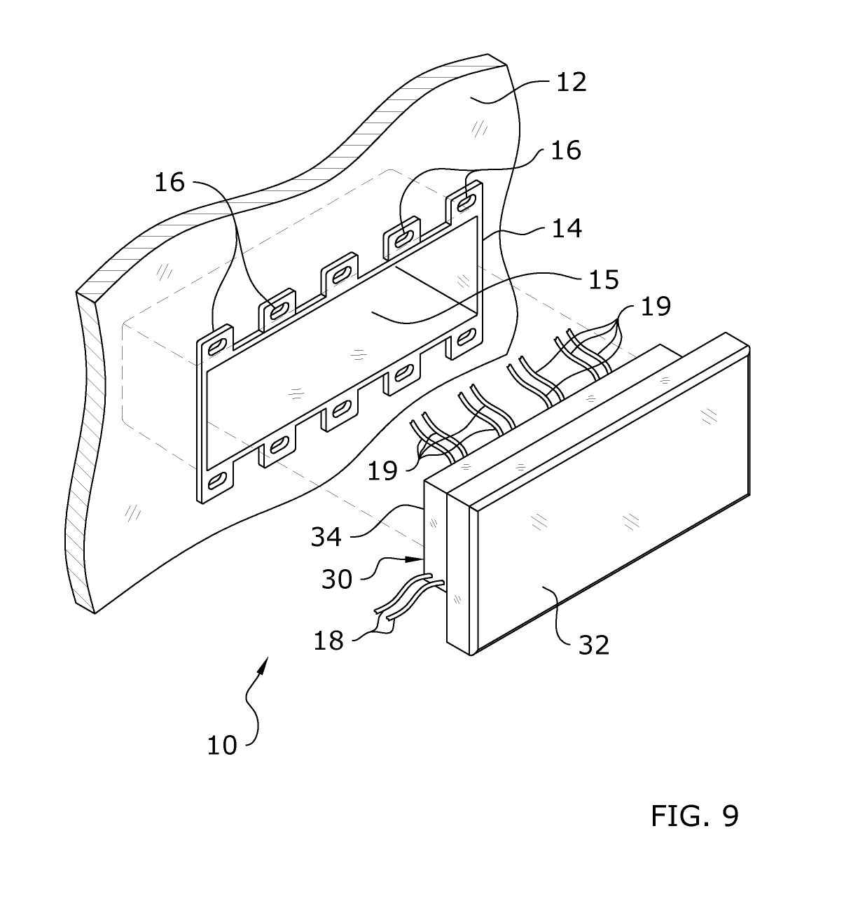

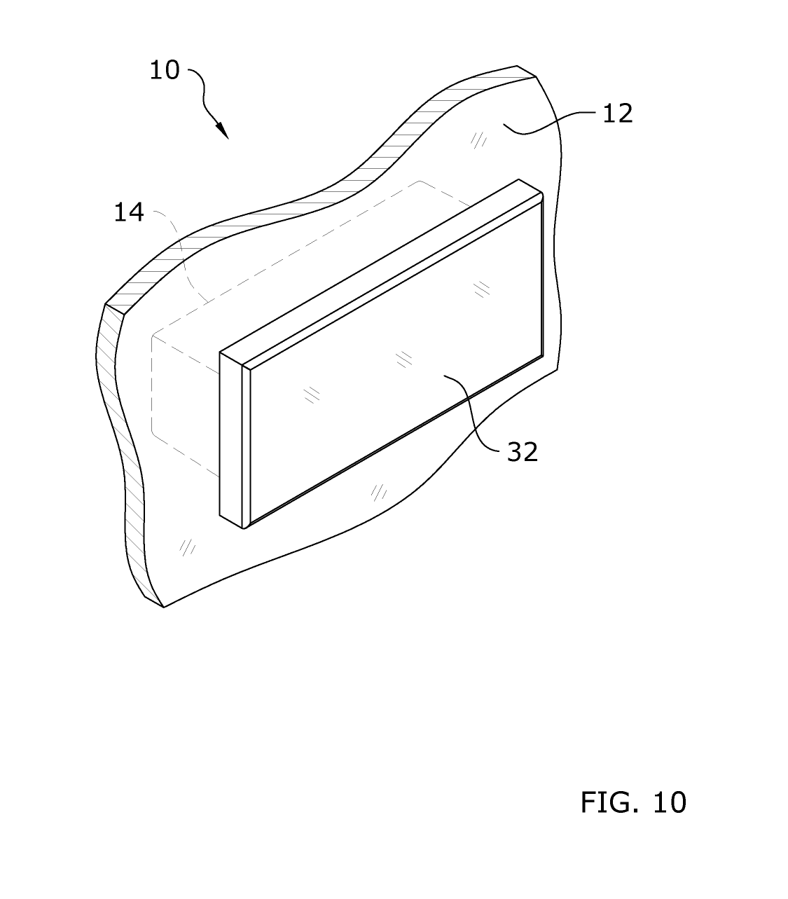

FIGS. 9 and 10 illustrate an electrical box 14 comprised of a conventional multi gang box that is adapted to receive a plurality of electrical switches. The electrical box 14 illustrated in FIGS. 9 and 10 preferably has a size of approximately 3 inches tall, a width greater than the height and 2.5 inches deep. The width of the conventional multi gang box is dependent upon the number of electrical switches or electrical outlets the multi gang box is designed to receive. Various other sizes may be utilized for the electrical box 14 illustrated in FIGS. 9 and 10.

### C. Housing

FIGS. 1 through 7 illustrate a preferred embodiment of the housing 30 formed and adapted to fit within an electrical box 14 having a single gang structure. The housing 30 is preferably comprised of a material that is not electrically conductive such as plastic or PVC. The housing 30 is comprised of a hollow structure having an interior space that receives and protects the low voltage power supply 60, a portion of the power switch 40 and a portion of the dimmer switch 50.

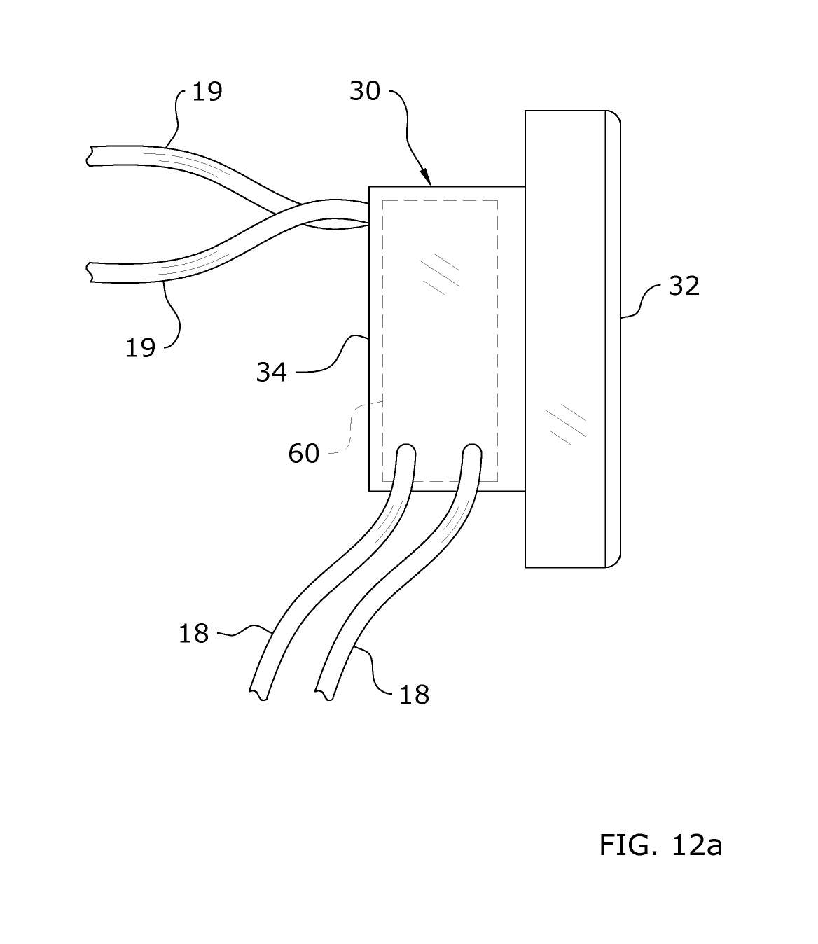

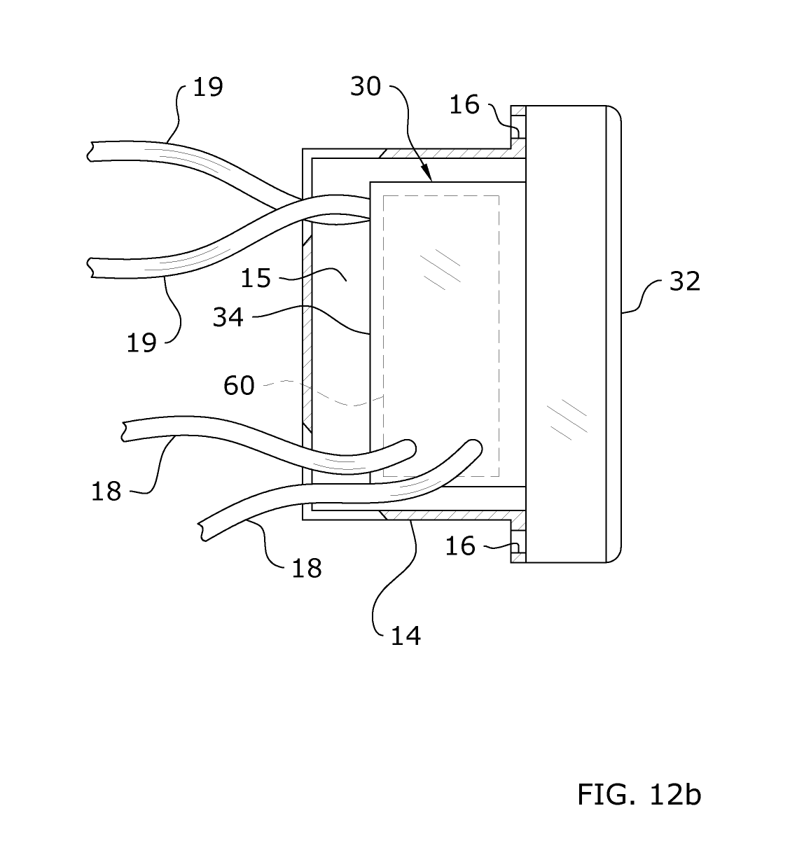

The housing 30 includes a rear portion 34 and a front portion 32 as illustrated in FIG. 4b of the drawings. The rear portion 34 of the housing 30 is adapted to fit within a box interior 15 of the electrical box 14 as best illustrated in FIGS. 4b and 12b of the drawings. At least a portion of the front portion 32 is positioned outside of the electrical box 14 as illustrated in FIG. 4b of the drawings. The power switch 40 and dimmer switch 50 are attached to the front portion 32 of the housing 30 to allow for access by a user outside of the wall 12.

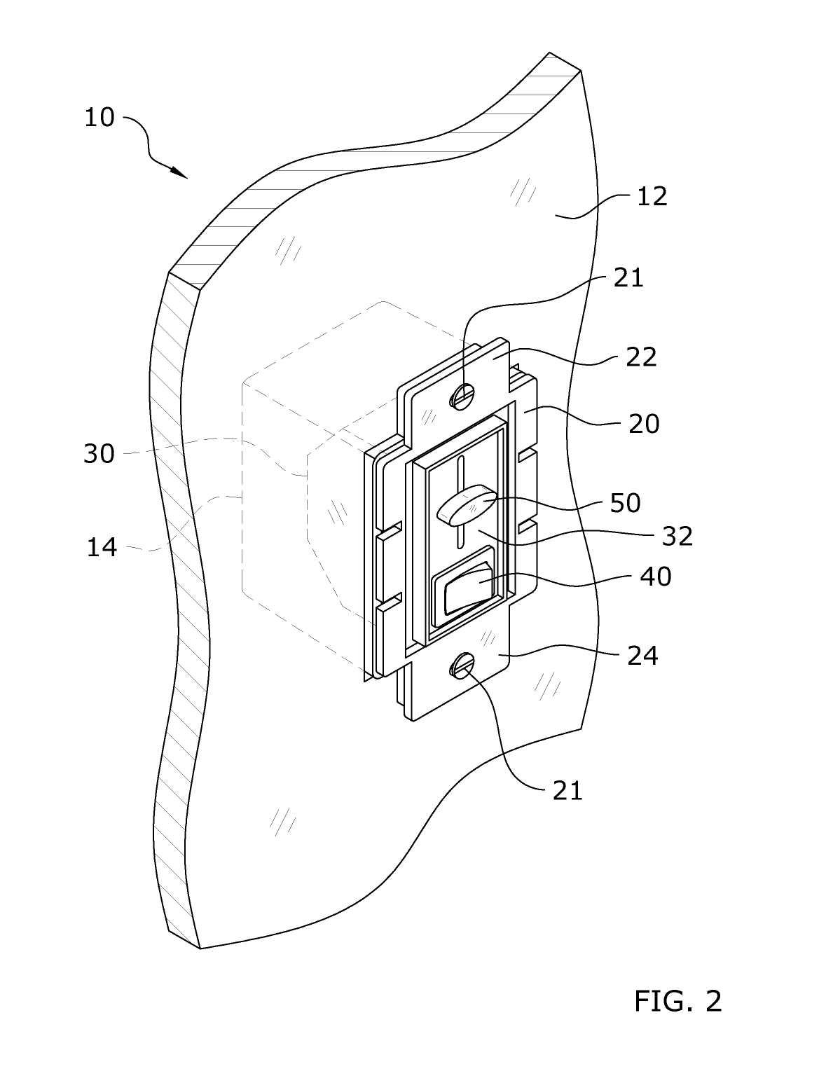

The housing 30 further preferably includes a front plate 20 having an upper bracket 22 with an upper opening 23 and a lower bracket 24 with a lower opening 25. The front plate 20 extends outwardly from a perimeter of the housing 30 preferably parallel with respect to a front surface of the front portion 32 of the housing 30 as illustrated in FIGS. 1 and 2 of the drawings. The upper opening 23 of the front plate 20 is aligned with the upper tab aperture and the lower opening 25 of the front plate 20 is aligned with the lower tab aperture to receive an upper fastener and a lower fastener respectively as illustrated in FIGS. 1 and 2 of the drawings. The front plate 20 is attached to an outside of the electrical box 14 when the housing 30 is attached within the electrical box 14 as illustrated in FIG. 4b of the drawings.

The housing 30 has a shape and size that is smaller than the box interior 15 of the electrical box 14 as illustrated in FIGS. 1, 2, 4b, 9, 12a and 12b of the drawings. In particular, the housing 30 has a height less than the interior height of the box interior 15, a width less than the interior width of the box interior 15 and a depth less than the interior depth of the box interior 15. For example, the single gang box style for the electrical box 14 shown in FIGS. 1 through 3, the housing 30 preferably has a height less than 3 inches, a width less than 2 inches and a depth less than 2.5 inches. For the multi gang box style for the electrical box 14 shown in FIGS. 9 and 10, the housing 30 preferably has a height less than 3 inches, a width less than the width of the electrical enclosure and a depth less than 2.5 inches.

### D. Low Voltage Power Supply

A low voltage power supply 60 is positioned within the housing 30 to provide a low voltage direct current power source for the light unit 11 electrically connected to the low voltage power supply 60. FIGS. 1 through 8 illustrate various switches that are electrically connected to the low voltage power supply 60 and attached to the housing 30. FIGS. 9 through 14 illustrate wherein a power switch 40 is not connected to the low voltage power supply 60 and wherein the low voltage power supply 60 is comprised of a stand-alone unit positioned within the electrical box 14.

The low voltage power supply 60 preferably is completely enclosed by the housing 30 as illustrated in FIGS. 4a and 4b of the drawings. The low voltage power supply 60 is preferably comprised of an alternating current (AC) to direct current (DC) converter (a.k.a. AC/DC converter, AC/DC power supply) wherein high voltage AC electrical power (e.g. 120V AC) is converted to low voltage DC electrical power (e.g. 12V DC). The low voltage power supply 60 preferably converts the high voltage AC electrical power to a low voltage DC electrical power ranging from 5V DC to 48V DC (e.g. 12V DC, 24V DC). The low voltage power supply 60 preferably converts 120V AC electrical power to 12V DC electrical power.

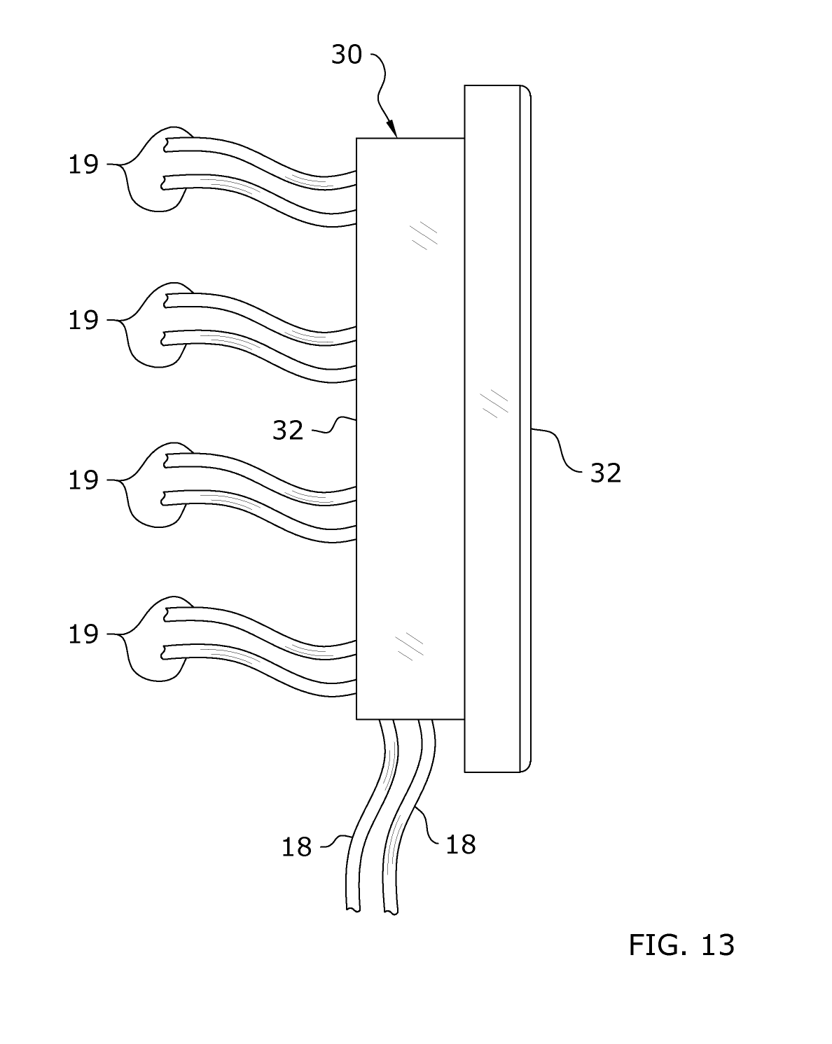

As shown in FIGS. 1 and 13 of the drawings, a plurality of high voltage wires 18 extend through the housing 30 and are electrically connected to the low voltage power supply 60. The plurality of high voltage wires 18 are adapted to provide high voltage alternating current (AC) electrical power from a high voltage power supply 13 (e.g. the AC power supply for a house or building structure) to the low voltage power supply 60 for conversion to low voltage direct current (DC) electrical power to electrically power the light unit 11. It is preferable to have a single set of high voltage wires 18 coming into the low voltage power supply 60 even if there are more than one set of low voltage wires 19 coming out of the low voltage power supply 60. However, more than one set of high voltage wires 18 may be connected to the low voltage power supply 60. The high voltage wires 18 are connected to high voltage connecting wires within the building to provide the high voltage AC power to the low voltage power supply 60.

A plurality of low voltage wires 19 extend through the housing 30 and are electrically connected to the low voltage power supply 60 as further shown in FIGS. 1 and 13 of the drawings. The plurality of low voltage wires 19 are adapted to be electrically connected to and provide a low voltage direct current electrical power to at least one light unit 11. The low voltage wires 19 are electrically connected either directly to the light units 11 or to connecting wires that are connected to the light units 11.

FIGS. 1 and 4a illustrate a single set (single pair) of low voltage wires 19 extending from the housing 30 to electrically power a single light unit 11. FIGS. 9, 13 and 14 illustrate a plurality of sets (two or more pairs) of low voltage wires 19 extending from the housing 30 to electrically power a corresponding plurality of light units 11. Each set of low voltage wires 19 preferably provides the same voltage of DC power such as 12V DC. It is further preferable that a single low voltage power supply 60 is used to provide the low voltage direct current electrical power to the plurality of sets of low voltage wires 19.

### E. Power Switch

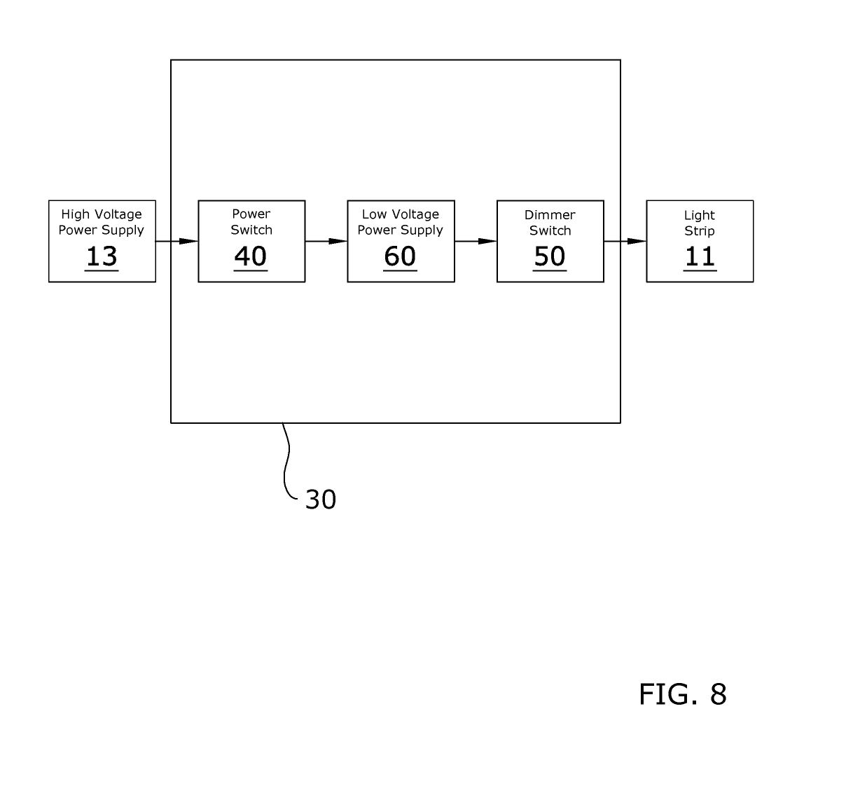

FIGS. 1 through 5 illustrate a power switch 40 attached to the front portion 32 of the housing 30. The power switch 40 is electrically connected to the low voltage power supply 60 within the housing 30 to control the low voltage direct current via the low voltage wires 19. The power switch 40 is preferably electrically connected between the high voltage power supply 13 and the low voltage power supply 60 as shown in FIG. 8 of the drawings, however, the power switch 40 may be electrically connected between the low voltage power supply 60 and the light unit 11.

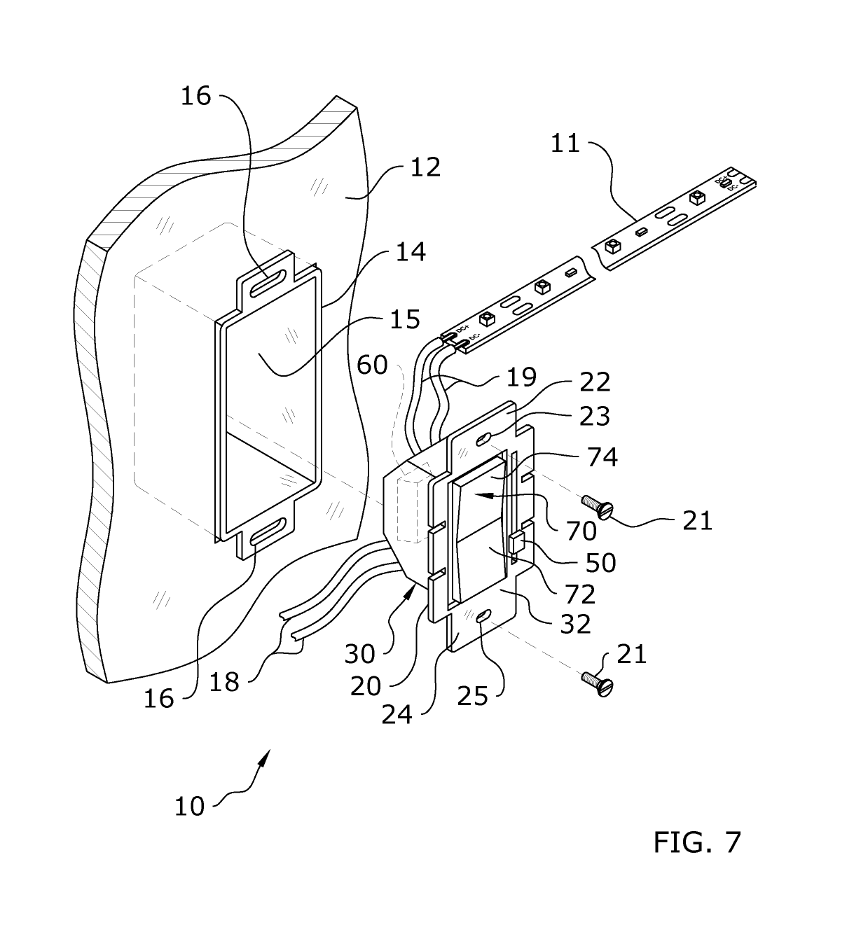

The power switch 40 may be comprised of various switch structures capable of being opened to turn off the electrical power or closed to turn on the electrical power to the low voltage power supply 60. FIG. 7 illustrates where the power switch 40 is comprised of a larger toggle switch 70 having a first portion 72 and a second portion 74 above the first portion 72 which represents the open or closed state of the power switch 40.

### F. Dimmer Switch

A dimmer switch 50 is further preferably attached to the front portion 32 of the housing 30 for access by the user as illustrated in FIGS. 1 through 5 of the drawings. The dimmer switch 50 is electrically connected to the power switch 40 to control a voltage level of the low voltage direct current thereby allowing for selective dimming of the light unit 11 by the user. The power switch 40 may be positioned below the dimmer switch 50 as shown in FIG. 1 or to the side of the dimmer switch 50 as shown in FIG. 7.

The dimmer switch 50 is preferably comprised of a sliding switch having a first position for a first voltage level and a second position opposite of the first position for a second voltage level for the low voltage direct current, wherein the second voltage level is greater than the first voltage level. As the user moves the dimmer switch 50 from the first position towards the second position, the brightness of the light unit 11 is increased and when the user moves the dimmer switch 50 from the second position towards the first position the brightness of the light unit 11 is decreased.

### G. Light Unit

As discussed previously, the present invention is designed to illuminate one or more light units 11. The light unit 11 is preferably comprised of a light strip and is further preferably comprised of a flexible light emitting diode (LED) light strip as illustrated iN FIGS. 1 and 7 of the drawings. The flexible LED light strip includes a plurality of light emitting diodes (LEDs) that are spaced apart and are electrically powered by DC voltage that may range from 5V DC to 48V DC (e.g. 12V DC, 24V DC). The flexible LED light strip may have various lengths (e.g. 9 feet, 30 feet, 45 feet, 50 feet, 55 feet or longer) and widths. One or both of the ends of the flexible LED light strip may include electrical connectors for electrically connecting to the low voltage wires 19 or an electrical connector that is electrically connected to the low voltage wires 19.

### H. Operation of Preferred Embodiment

In use, the electrical box 14 is mounted within the wall 12 utilizing nails or other conventional fasteners 21. The user connects the high voltage wires 18 to the high voltage power supply 13 within the building and also connects the low voltage wires 19 to one or more light units 11. The user then positions the rear portion 34 of the housing 30 into the front opening of the electrical box 14 and aligns the upper opening 23 and the lower opening 25 of the brackets 22, 24 with the respective upper/lower tab apertures 16 within the electrical enclosure as illustrated in FIG. 1 of the drawings.

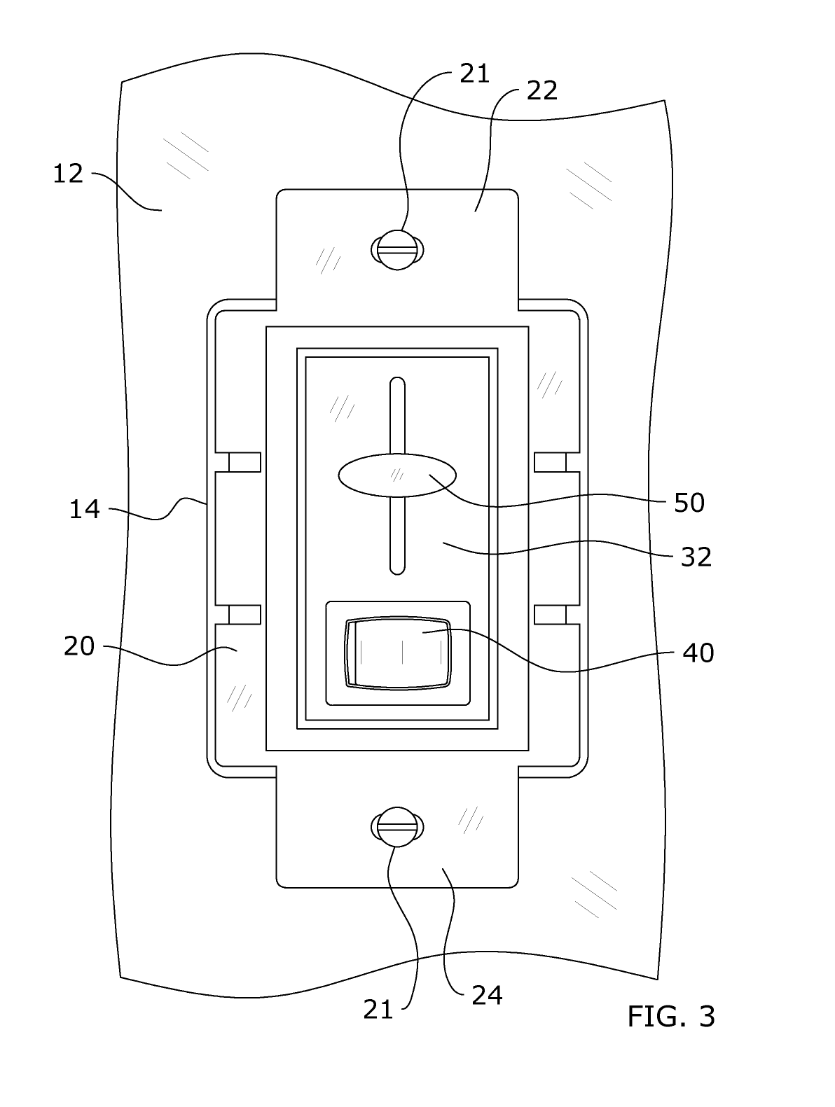

The front plate 20 of the housing 30 is then secured to the electrical enclosure with conventional fasteners 21 as illustrated in FIGS. 2 and 3 of the drawings. A cover plate may be attached over the front plate 20 of the housing 30 and secured to the electrical box 14 similar to conventional switch and outlet plates to provide a finished appearance.

After everything is properly connected, the user then may close the power switch 40 to provide high voltage AC electrical power to the low voltage power supply 60 which converts the same to low voltage DC electrical power which powers the light unit 11. The dimmer switch 50 (if connected) may be used to control the brightness of the light unit 11 by controlling the voltage level provided to the light unit 11. When finished, the user may turn off the light unit 11 by opening the power switch 40.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A low voltage power supply system, comprising:
a housing formed and adapted to fit within an electrical box;
a low voltage power supply positioned within said housing;
a plurality of high voltage wires electrically connected to said low voltage power supply, wherein said plurality of high voltage wires are adapted to provide high voltage alternating current power to said low voltage power supply; and
a plurality of low voltage wires electrically connected to said low voltage power supply, wherein said plurality of low voltage wires are adapted to provide a low voltage direct current to at least one light unit.

2. The low voltage power supply system of claim 1, wherein said plurality of low voltage wires are electrically connected to said least one light unit.

3. The low voltage power supply system of claim 2, wherein said least one light unit is comprised of a flexible light emitting diode light strip.

4. The low voltage power supply system of claim 3, wherein said low voltage power supply is comprised of an alternating current to direct current converter

5. The low voltage power supply system of claim 1, wherein said housing includes a rear portion and a front portion, wherein said rear portion is adapted to fit within a box interior of said electrical box.

6. The low voltage power supply system of claim 5, wherein at least a portion of said front portion is positioned outside of said electrical box.

7. The low voltage power supply system of claim 1, wherein said electrical box is comprised of a switch box.

8. The low voltage power supply system of claim 7, wherein said electrical box is comprised of a box structure having a front opening that receives said housing.

9. The low voltage power supply system of claim 8, wherein said electrical box is comprised of a rectangular cuboid structure.

10. The low voltage power supply system of claim 7, wherein said electrical box includes an upper tab having an upper tab aperture and a lower tab having a lower tab aperture.

11. The low voltage power supply system of claim 10, wherein said housing includes a front plate having an upper bracket with an upper opening and a lower bracket with a lower opening, wherein said upper opening is aligned with said upper tab aperture and said lower opening is aligned with said lower tab aperture to receive an upper fastener and a lower fastener respectively.

12. The low voltage power supply system of claim 11, wherein said front plate is attached to an outside of said electrical box and wherein said front plate extends outwardly from a perimeter of said housing.

13. The low voltage power supply system of claim 1, wherein said low voltage power supply is comprised of an alternating current to direct current converter.

14. The low voltage power supply system of claim 1, including a power switch attached to a front portion of said housing, wherein said power switch is electrically connected to said low voltage power supply within said housing to control said low voltage direct current via said low voltage wires.

15. The low voltage power supply system of claim 14, wherein said power switch is comprised of a toggle switch having a first portion and a second portion.

16. The low voltage power supply system of claim 14, including a dimmer switch attached to said front portion of said housing, wherein said dimmer switch is electrically connected to said power switch to control a voltage level of said low voltage direct current.

17. The low voltage power supply system of claim 16, wherein said dimmer switch is comprised of a sliding switch having a first position for a first voltage level and a second position for a second voltage level for said low voltage direct current, wherein said second voltage level is greater than said first voltage level.

18. The low voltage power supply system of claim 17, wherein said power switch is positioned below said dimmer switch.

19. The low voltage power supply system of claim 1, wherein said electrical box is comprised of a multi gang box.

20. The low voltage power supply system of claim 1, wherein said plurality of low voltage wires are comprised of two or more pairs of wires adapted to electrically power a corresponding number of light units.
